(19) United States
(12) Patent Application Publication
(10) Pub. No.: US 2016/0349195 A1
(43) Pub. Date: Dec. 1, 2016

(54) IMAGE PROCESSING DEVICES, IMAGE PROCESSING SYSTEM, IMAGE PROCESSING METHOD, AND NON-TRANSITORY RECORDING MEDIUM

(71) Applicant: CANON KABUSHIKI KAISHA, Tokyo (JP)

(72) Inventor: Noboru Inoue, Kawasaki-shi (JP)

(21) Appl. No.: 15/161,047

(22) Filed: May 20, 2016

(30) Foreign Application Priority Data
May 29, 2015 (JP) 2015-110213

(51) Int. Cl. G01N 23/20

(52) U.S. Cl. CPC G01N 23/20; G01N 2223/051; G01N 2223/401

(57) ABSTRACT

An image processing device acquires a radiography image and detects the use or non-use of a grid for capturing the radiography image. If the use of the grid is detected, the image processing device performs a grid pattern reduction process. If the non-use of the grid is detected, the image processing device performs a scattered-ray-component reduction process.

### BACKGROUND OF THE INVENTION

Field of the Invention

The disclosure of the specification relates to an image radiography system.

Description of Related Art

When an object is irradiated with radiation to capture a radiography image, scattered rays that are scattered in the object cause the contrast of the radiography image to deteriorate.

To reduce the scattered rays that reach a radiation detector provided for capturing the radiography image, a scattered-ray reduction grid (hereinafter, referred simply as a “grid”) may be disposed between the object and the radiation detector for the radiography. The grid reduces not only the scattered rays but also some of the primary radiation that travels straight from a radiation generating device to the radiation detector. Accordingly, the use of the grid for capturing a radiography image leads to generation of a periodic signal (grid pattern) in the radiography image.

US Patent Application Publication No. 2002/0015475 discloses a way of increasing contrast by performing a grid pattern reduction process on a radiography image captured using a fixed grid, and in contrast by performing a gradation process on a radiography image captured without using the grid.

The gradation process is a process for enhancing the contrast in a specific pixel value range. The gradation process has sufficiently satisfied the image quality desired in the past, but further higher image quality has been desired in recent years in consideration of the behavior of the scattered rays influenced by the thickness of the object and the radiation quality.

### SUMMARY OF THE INVENTION

According to some embodiments of the present invention, an image processing device includes an acquisition unit, a detector, a grid pattern reduction unit, a scattered-ray-component reduction unit, and a controller. The acquisition unit acquires a radiography image. The detector detects use or non-use of a grid for capturing the radiography image. The grid pattern reduction unit reduces a grid pattern included in the radiography image. The scattered-ray-component reduction unit estimates a scattered-ray component included in the radiography image and performs reduction of the scattered-ray component. The controller performs control to cause the grid pattern reduction unit to perform processing if the detector detects the use of the grid and to cause the scattered-ray-component reduction unit to perform processing if the detector detects the non-use of the grid.

Further features of the present invention will become apparent from the following description of exemplary embodiments with reference to the attached drawings.

### BRIEF DESCRIPTION OF THE DRAWINGS

FIG. 1 is a diagram illustrating the configuration of a medical imaging system including an image processing device according to an embodiment of the invention.

FIG. 2 is a diagram illustrating the configuration of the image processing device according to the embodiment of the invention.

FIG. 3 is a flowchart illustrating a first example of a process according to the embodiment of the invention.

FIG. 4 is a flowchart illustrating a second example of the process according to the embodiment of the invention.

FIG. 5 is a flowchart illustrating a third example of the process according to the embodiment of the invention.

FIG. 6 is a diagram illustrating display output on a monitor by an image processing device according to an embodiment of the invention.

### DESCRIPTION OF THE EMBODIMENTS

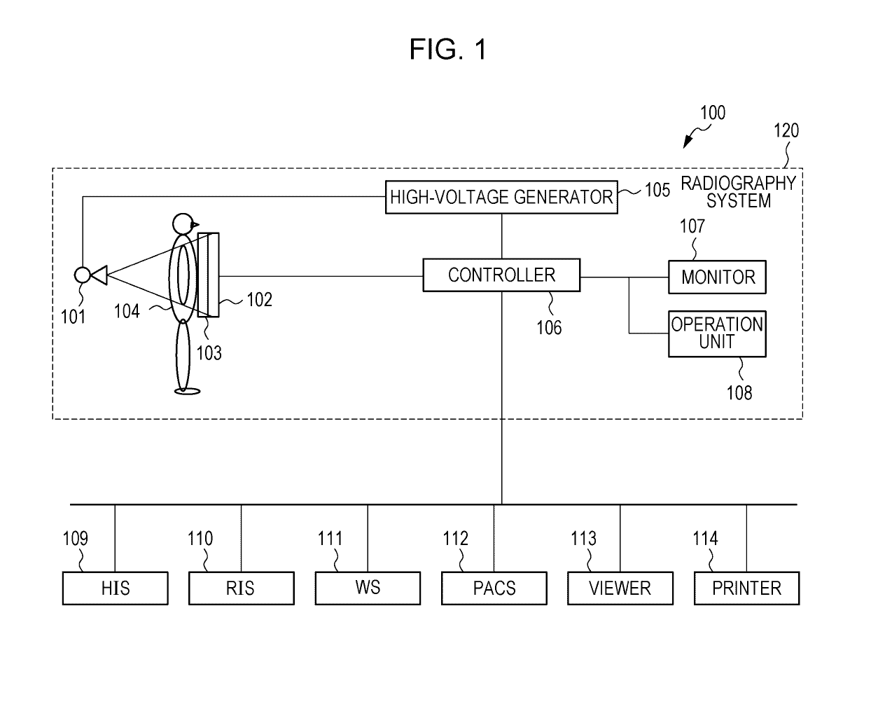

FIG. 1 illustrates a medical imaging system 100 including an image processing device according to a first embodiment of the invention. The image processing device according to the first embodiment corresponds to a controller 106 included in a radiography system 120. The medical imaging system 100 is an information system for unitedly managing and providing medical images including radiography images for medical care. The medical imaging system 100 includes, for example, a hospital information system (HIS) 109, a radiography information system (RIS) 110, a work station (WS) 111, a picture archiving and communication system (PACS) 112, a viewer 113, and a printer 114. The HIS 109 is a system that comprehensively manages patient information and medical care information including information regarding radiography tests and the like. The RIS 110 is a system that manages the order of the radiography. The WS 111 is an image processing terminal and performs image processing on a radiography image captured using the radiography system 120. Instead of the WS 111, one or more computers having software having the same function installed thereon may be used. The PACS 112 is a database system that retains images obtained by performing radiography imaging in the radiography system 120 or by using other similar medical image capturing devices. The PACS 112 includes a memory section (not illustrated) and a controller. The memory section stores accompanying information such as medical images, radiography settings for the medical images, and patient information. The controller (not illustrated) controls the information stored in the memory section. The viewer 113 is a terminal for diagnostic imaging, reads out an image stored in the PACS 112 or other components, and displays the image for a diagnosis. The printer 114 is, for example, a film printer and outputs an image stored in the PACS 112 to a film.

The radiography system 120 includes a radiography system that performs radiography and is provided for acquiring a radiography image of an object 104. The radiography system 120 uses, for example, X-rays as radiation. The radiography system 120 includes an X-ray source 101, a flat panel detector (FPD) 102 as a radiation detector, and the controller 106. The X-ray source 101 is an example of a radiation generating device. These components are connected to each other with cables or a communication system. The controller 106 controls the radiography system 120. The controller 106 performs image processing on a captured radiography image and associates the image with radiography settings, patient information, and other information. The order for the radiography is transmitted from, for example, the RIS 110 to the controller 106. The controller 106 reads out the radiography settings from the memory section (not illustrated) in accordance with information input from the RIS 110. The controller 106 associates the information with the radiography image in accordance with, for example, the digital imaging and communications in medicine (DICOM) standards and generates a DICOM image file including information such as data regarding the radiography image, the patient information, and the radiography settings. The controller 106 transmits the image to the WS 111 and the PACS 112.

The X-ray source 101 may be an X-ray tube or any other radiation source suitable for obtaining a medical image or other images. When an operator activates an exposure switch (not illustrated), a high-voltage generator 105 applies high-voltage pulses to the X-ray source 101, and a region where an object 104 is disposed is exposed to X-rays. The high-voltage generator 105 may apply the high-voltage pulses to the X-ray source 101 under the control of the controller 106. If a grid 103 is used to capture a radiography image, the grid 103 is disposed between the FPD 102 and the object 104. The X-rays transmitted the object 104 or passing through a portion around the object 104 enter the FPD 102 that is an X-ray detector. The FPD 102 is controlled by the controller 106, converts the incident X-rays into electrical signals, and transmits the electrical signals as a digital image to the controller 106. For example, the FPD 102 includes a fluorescence body that converts the incident X-rays into visible light, photodiodes that detect the visible light and that convert the visible light into electrical signals, and an analog-to-digital (A/D) converter that converts the electrical signals into digital signals. In another example, the FPD 102 includes a converter (not illustrated) made of amorphous selenium for directly converting the X-rays into the electrical signals.

The digital image undergoes image processing performed by the controller 106 and the WS 111 and is stored in the PACS 112 or other components. It is only required that the components included in the medical imaging system 100 are connected to each other through a bus or other communication systems. The components can also be arranged remotely from each other.

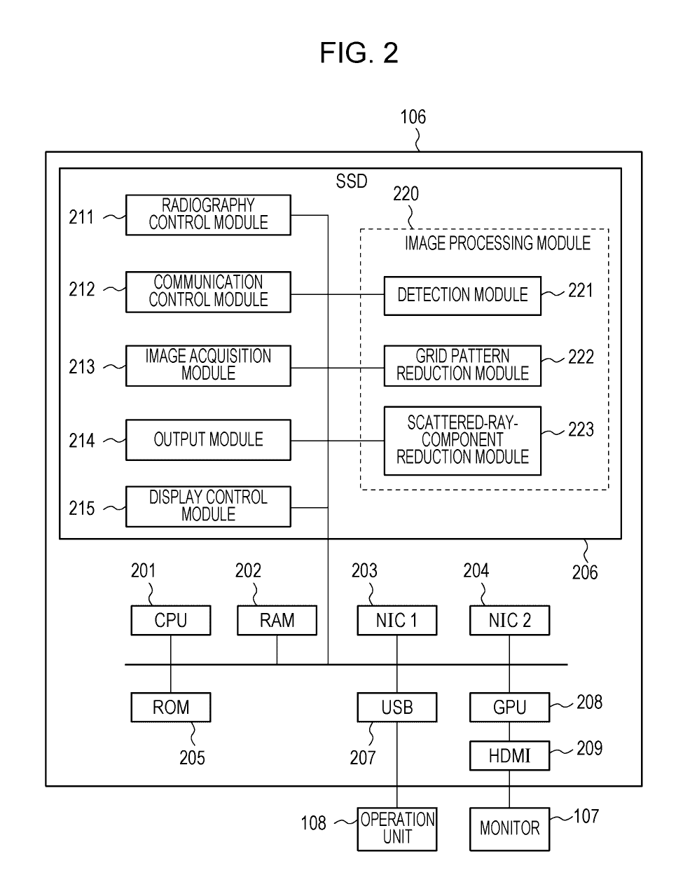

The configuration of the image processing device according to the first embodiment will be described in detail based on FIG. 2. The image processing device according to the first embodiment is the controller 106 connected to the medical imaging system 100 and is implemented by one or more computers. The computer included in the controller 106 includes a central processing unit (CPU) 201 that is a main controller, a random access memory (RAM) 202 that is a memory section, a read only memory (ROM) 205, a solid state drive (SSD) 206, a graphics processing unit (GPU) 208 that is a graphics controller, network interface cards (NICs) 203 and 204 that are communication units, a universal serial bus (USB) 207 that is a connection unit, and a high definition multimedia interface (HDMI (registered trademark)) 209 which are communicably connected to each other through an internal bus. The CPU 201 is a control circuit that controls the controller 106 and components connected to the controller 106. The RAM 202 is a memory for storing programs for executing processes to be performed by the controller 106 and the components connected to the controller 106 and also for storing various parameters to be used for the image processing. The CPU 201 serially executes commands included in the programs loaded in the RAM 202, and the image processing (described later) is thereby implemented. As for the communication units, for example, the first NIC 203 is connected to an access point in the facility where the radiography is performed, and the second NIC 204 is connected to an access point where communication in the medical imaging system 100 is relayed. The SSD 206 stores the programs as described above, radiography images obtained by radiography, the accompanying information, and other various parameters. The USB 207 is connected to an operation unit 108. The GPU 208 is an image processing unit and executes the image processing under the control of the CPU 201. An image obtained as a result of the image processing is output to a monitor 107 through the HDMI (registered trademark) 209 and displayed thereon. The monitor 107 and the operation unit 108 may be integrated into a touch panel monitor.

The programs stored in the SSD 206 include, for example, a radiography control module 211, a communication control module 212, an image acquisition module 213, an output module 214, a display control module 215, and an image processing module 220.

The radiography control module 211 is a program for causing the CPU 201 to control steps from radiography imaging through execution of the image processing according to the first embodiment to outputting of a corrected image having undergone the image processing. The radiography control module 211, for example, designates radiography settings in accordance with input manipulation and transmits a signal used for requesting transmission of the state of the FPD 102. The radiography control module 211 also determines the next process in accordance with the result of a process performed by a corresponding one of the modules (described later) and causes a module to execute the next process. For example, the radiography control module 211 performs control to cause the image processing module 220 (described later) to perform the image processing and further to cause a scattered-ray-component reduction module 223 to execute a process based on the corrected image having undergone the image processing. The radiography control module 211 performs control to adjust the degree of reduction of a scattered-ray component based on the contrast ratio of a captured radiography image or the corrected image. For example, if the contrast ratio of the corrected image has not reached a predetermined value yet, the radiography control module 211 performs control to cause the scattered-ray-component reduction module 223 to execute the process further. In another embodiment, the radiography control module 211 refers to the radiography settings and performs control to cause the scattered-ray-component reduction module 223 not to execute the process. In still another embodiment, the radiography control module 211 performs control to adjust the degree of reduction of a scattered-ray component in accordance with the input manipulation. The radiography control module 211 retains, in the RAM 202 or the SSD 206, an X-ray tube voltage, X-ray tube current, an irradiation period of time, and a radiography target part among the radiography settings input from the RIS 110 and performs control to adjust the degree by using one or more of the radiography settings.

The communication control module 212 controls communication performed by the first and second NICs 203 and 204. The communication control module 212 causes a signal for radiography to be transmitted, for example, in accordance with input from the operation unit 108, the signal causing the FPD 102 to transition to a ready-to-radiograph state.

The image acquisition module 213 is run by the CPU 201 to thereby control a step of acquiring an image to undergo the image processing according to the first embodiment. For example, the image acquisition module 213 causes the NIC 203 to receive a radiography image captured by the FPD 102. When the radiography image is received, the image acquisition module 213 causes the NIC 203 to preferentially receive a reduced radiography image having a small amount of data and subsequently receive data regarding the radiography image other than the reduced image. The receiving of the radiography image is thereafter completed. The reduced image is acquired in such a manner that only some output signals are selectively read out from some of the FPD 102, for example, from the even numbered columns of radiation detecting elements (not illustrated) of the FPD 102. Alternatively, the reduced image is acquired by using only some output signals collectively read out from some elements. Still alternatively, the reduced image is acquired in such a manner that a read out image is divided into a plurality of small regions and representative values of the respective small regions are used. In another embodiment, the image acquisition module 213 causes the NIC 203 to receive a radiography image stored in the PACS 112 or another memory section (not illustrated) on the network. Alternatively, the image acquisition module 213 reads out a radiography image stored in the SSD 206 of the controller 106 or another memory section (not illustrated). The image acquisition module 213 may also perform well-known image processing before performing the image processing according to the first embodiment. For example, the image acquisition module 213 performs control to first perform adjustment of the sharpness and an analysis for a gradation process, subsequently a grid pattern reduction process or a scattered-ray-component reduction process, and thereafter the gradation process.

The image processing module 220 causes the CPU 201 to execute image processing appropriate for reducing the influence of the scattered rays on the captured radiography image in consideration of the presence of the grid and the radiography settings. Hereinafter, the image processing will be described in detail.

A detection module 221 is run by the CPU 201. The detection module 221 detects the use or non-use of the grid for capturing a radiography image and causes the RAM 202 or the SSD 206 to retain the detection result therein. For example, the detection module 221 analyzes a spatial frequency component of the captured radiography image in the vertical and horizontal directions and detects the use or non-use of the grid based on the presence or absence of a spatial frequency peak corresponding to a grid stripe. Alternatively, the detection module 221 refers to the radiography settings to detect the use or non-use of the grid. A sensor (not illustrated) that detects the installation of the grid by using a mechanical or electromagnetic mechanism is provided to the grid 103 or a casing (not illustrated) where the grid 103 is installed. Based on output from the sensor, the detection module 221 detects the use or non-use of the grid. The detection module 221 detects a periodical signal attributable to the grid from a region selected using statistical information in such a manner as disclosed in U.S. Patent Application Publication No. 2014/0219536. As detection methods, two or more of the detection methods herein described may be used, or the operator may select one of the methods. If an input image is a DICOM file, the detection module 221 detects the presence of the grid based on tag information indicating the presence of the grid used for the radiography.

A grid pattern reduction module 222 is run by the CPU 201 and thereby reduces the grid pattern included in the radiography image. The grid pattern reduction module 222 reduces moire caused by the grid pattern. The grid pattern reduction process may be executed by a well-known method such as a method disclosed in U.S. Pat. No. 7,474,774. By using the sensor (not illustrated) provided to the grid 103 or the casing (not illustrated) where the grid 103 is installed, the grid pattern reduction module 222 may obtain and use information regarding the orientation of the grid or the pitch of the radiation shielding members of the grid. Alternatively, the grid pattern reduction module 222 may also obtain a difference between an image obtained with only the grid 103 being installed and an image obtained with the grid 103 being not installed and may identify a grid image based on the difference. The grid pattern reduction module 222 may retain the grid image identified based on the difference in the SSD 206 and may use the grid image to reduce the grid pattern.

The scattered-ray-component reduction module 223 is run by the CPU 201 and thereby estimates and reduces the scattered-ray component included in the radiography image. For example, the scattered-ray-component reduction module 223 estimates the scattered-ray component by performing serial approximation calculation based on a formula approximately modeling the scattered rays from the primary radiation transmitted through the object. In another example, the scattered-ray-component reduction module 223 estimates the scattered-ray component by simulating the behavior of the scattered rays based on the radiography image. The scattered-ray-component reduction module 223 may associate the result of the simulation performed in advance with the radiography settings, retain the result in the SSD 206, refer to the result, and estimate the scattered-ray component. In another example, the scattered-ray-component reduction module 223 associates the rate of attenuation of the primary radiation and the scattered rays with the characteristics of the grid, retains the rate in the SSD 206, refers to the rate, and estimates the scattered-ray component. Further, the scattered-ray-component reduction module 223 is controlled by the radiography control module 211 and adjusts the degree of reduction of the scattered-ray component.

The output module 214 is run by the CPU 201 and thereby controls output of the corrected image having the grid pattern and the scattered-ray component that are reduced by performing the image processing according to the first embodiment. For example, the output module 214 outputs the corrected image to the monitor 107 and thereby causes the monitor 107 to display the corrected image. The output module 214 also outputs the corrected image, for example, through the NIC 204 to the PACS 112 and the printer 114. In this way, the corrected image is stored in the PACS 112, and the printer 114 outputs the corrected image onto a film or the like. In addition, the output module 214 may be run by the CPU 201 to cause the corrected image to be output and be thereby stored in another memory section (not illustrated) in or outside the controller 106. Further, the output module 214 outputs the corrected image in association with various pieces of information in accordance with the DICOM standard. A modality is an image-generating unit that radiographs a patient and generates medical images. A modality corresponds to the radiography system 120 in the medical imaging system 100, the radiography system 120 including, for example, the X-ray source 101 and the FPD 102. At this time, the corrected image is associated with DX that denotes digital radiography as a modality tag (0008, 0060). In the case of moving image radiography, the corrected image is associated with RF that denotes radio fluoroscopy. Further, in a case where the corrected image is stored in the PACS 112 in accordance with the DICOM standard, the output module 214 associates the corrected image with SOP Class UID 1.2.840.10008.5.1.4.1.1.1.1 that denotes the combination of a digital X-ray image as an object, and storage as a service, and that serves as a SOP Class UID tag (0008, 0016) used for designating a service-object pair. The output module 214 executes a process for changing the format of the image in accordance with the output destination.

The display control module 215 controls the content of display on the monitor 107. The display control module 215 performs control to display, on the monitor 107, information such as patient information, radiography setting information, and information indicating the state of the FPD 102. The display control module 215 causes the monitor 107 to display these pieces of information together with the corrected image described above.

The display control to cause the monitor 107 to display the corrected image is performed by the output module 214 but may be performed by the display control module 215. In this case, the display control module 215 causes the monitor 107 to display the captured radiography image or the corrected image depending on the situation. Some or all of the components of the image processing device illustrated in FIG. 2 are not limited to the components of the controller 106. It is only required that the components are included in the medical imaging system 100. For example, an image processing device capable of executing image processing programs including the image acquisition module 213, the output module 214, and the image processing module 220 may be provided separately from the controller 106 that runs the radiography control module 211. Some or all of the components may also be included in, for example, the WS 111. The components of the image processing device illustrated in FIG. 2 may be redundantly included in different devices, and a device for executing a process may be selected in accordance with the designation of the operator. Further, the image processing device may be implemented by a workstation, a server, and a memory device connected through a network, and communication with these devices may be performed as necessary to perform the image processing according to the first embodiment. Each module may be an independent circuit including parts such as a processor or may be a function implemented as software by one processor.

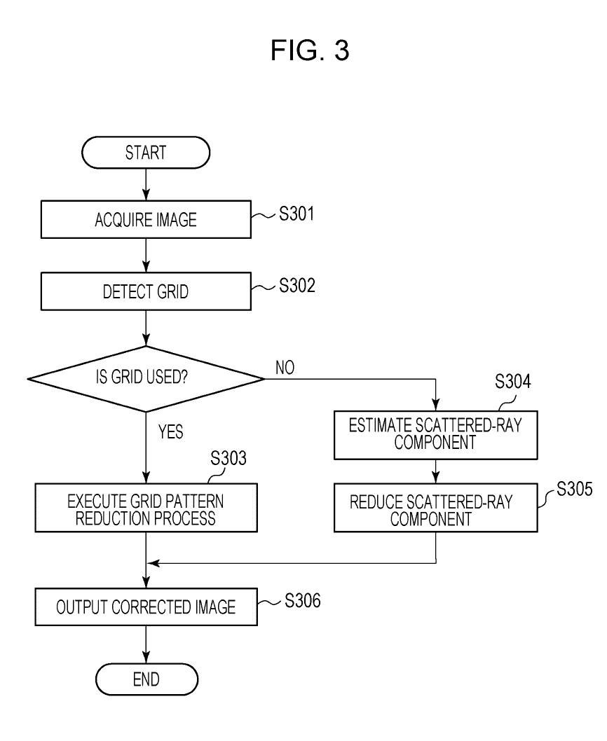

The process according to the first embodiment will be described in detail based on FIG. 3. The process described below is executed by the CPU 201 or the GPU 208 of the controller 106 unless otherwise particularly noted.

In step S301, the CPU 201 runs the image acquisition module 213, and a radiography image is thereby acquired, the radiography image being captured in such a manner that the object 104 is irradiated with the radiation. The radiography is performed based on the radiography settings. The image acquisition module 213 is run by the CPU 201 and thereby acquires the radiography settings input from the RIS 110. The radiography settings include an imaging setting, an irradiation setting, a transfer setting, an image processing setting, a display setting, an output setting, and other settings. The imaging setting is a setting related to the gain of the FPD 102, binning, and an accumulation period of time. The irradiation setting is a setting related to an X-ray tube voltage, X-ray tube current, and an X-ray irradiation period of time of the X-ray source 101. The transfer setting is a setting used when the captured radiography image is transferred from the FPD 102 to the controller 106. The image processing setting is a setting for determining whether to perform one of the various image processing operations and for designating the degree of the processing operation. The display setting is a setting for displaying, on the monitor 107, information appropriate for the radiography method. The output setting is a setting related to the output destination of the captured radiography image. The protocol for radiography is determined based on the radiography settings. The protocol may be automatically selected based on the radiography settings or may be determined based on the input manipulation. When the FPD 102 transitions to the accumulation state, the monitor 107 displays the content to that effect. After confirming display indicating that the transition to the accumulation state is completed, the operator presses the exposure switch (not illustrated), and the object 104 is exposed to the X-ray.

The radiography image captured by the radiation from the X-ray source 101 is used as an input image to undergo the image processing according to the first embodiment. In another example, the input image is a reduced image having a small amount of data. Data transmission from the FPD 102 and the subsequent image processing can be performed at a higher speed. Since scattered-ray components are mainly composed of low frequency components, the use of the reduced image for estimating a scattered-ray component has a small influence on the accuracy of estimation of the scattered-ray component.

In another example, the captured radiography image undergoes well-known image processing and is thereafter used as an input image to undergo the image processing according to the first embodiment. For example, correction for defective pixels of the FPD 102 is performed on the captured radiography image. Further, the input image is analyzed in step S301 to perform the gradation conversion in a subsequent step (described later). For example, an input density value correlated with an output density value after the gradation conversion is set in accordance with the analysis.

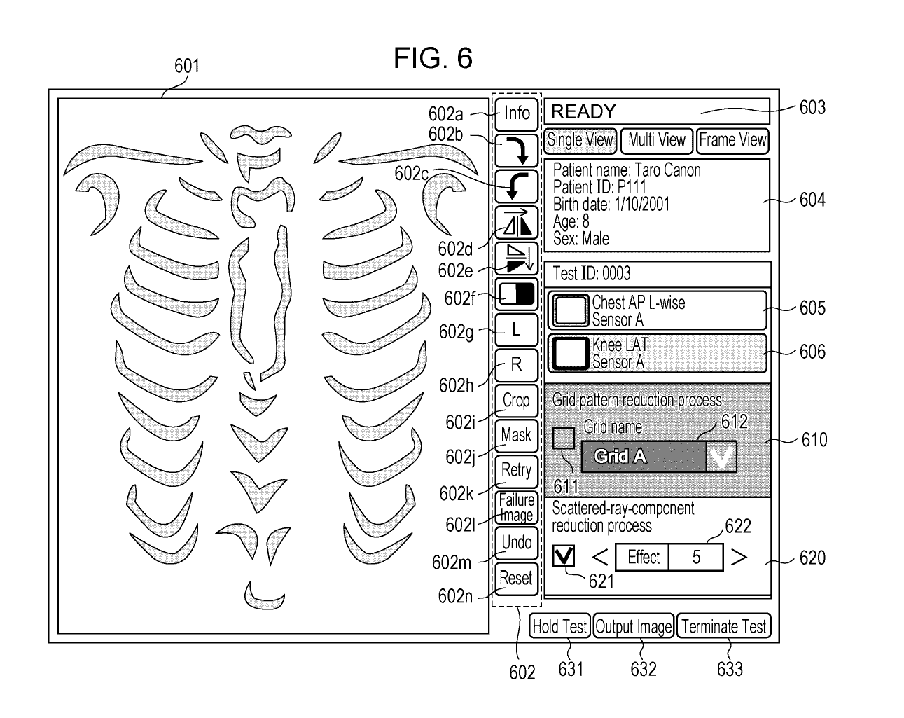

In step S302, the CPU 201 runs the detection module 221, the use or non-use of a grid for capturing a radiography image is thereby detected, and the detection result is retained in the RAM 202 or the SSD 206. For example, a spatial frequency component is analyzed in a specific direction in the input image. If a grid pattern is present in a direction orthogonal to the specific direction, the spatial frequency band of the grid pattern has an intense response. If the analysis described above is performed in the vertical and horizontal directions of the input image, the use or non-use of a grid for radiography can be detected based on the presence or absence of the spatial frequency component corresponding to the grid pattern. A longitudinal direction and a lateral direction of, for example, a rectangular radiography image like a radiography image 601 in FIG. 6 are herein respectively a “vertical direction” and a “horizontal direction”. Information obtained by the analysis may be used to identify the type of grid used. For example, the type of grid used is identified in such a manner that a gird ratio of the grid is acquired based on the cycles of the grid pattern.

The detection module 221 causes the memory section to retain information indicating whether a grid is present, in association with the input image. The information indicating whether a grid is present is expressed by using, for example, 0 or 1 or an integer value and is retained in a predetermined storage area. If the use of the grid is detected, the RAM 202 or the SSD 206 stores a “present” grid flag for the input image. The type of grid may also be retained together. If the non-use of the grid is detected, the RAM 202 or the SSD 206 stores an “absent” grid flag for the input image. It is only required that whether the grid is used is distinguishable. For example, if the use of the grid is detected, only the “present” grid flag may be stored. In another embodiment, if the input image is a DICOM file, the type of the grid detected by the detection module 221 is retained in the tag indicating the grid used. If the use of the grid is detected, the process proceeds to step S303. If the non-use of the grid is detected, the process proceeds to step S304.

In step S303, the CPU 201 runs the grid pattern reduction module 222, and the grid pattern included in the radiography image is thereby reduced. For example, the spatial frequency component corresponding to the grid pattern analyzed in step S302 is extracted and reduced. In step S304, whether the input image is acquired with the grid used may also be confirmed based on the information indicating whether a grid is present. For example, whether the “present” grid flag is stored in the predetermined storage area is confirmed. If it is not confirmed that the input image is acquired by using the grid, the operator may be notified of the content to that effect before the grid pattern reduction process is performed on the input image. Specifically, the detection module 221 causes the display control module 215 to perform control such that the monitor 107 displays a screen notifying “the input image is not an image captured by using the grid”.

In step S304, the CPU 201 runs the scattered-ray-component reduction module 223, and a scattered-ray component included in the radiography image is thereby estimated. In the radiography image, the scattered X-ray component of a scattered X-ray that is scattered in the object 104 is superposed on a primary X-ray component of a primary X-ray that linearly travels and reaches the elements of the FPD 102 from the X-ray source 101. The relation can be expressed by Formula 1 where M denotes an input image, P denotes a primary X-ray component, and S denotes a scattered X-ray component.

M=P+S (Formula 1)

For example, if an approximation of the scattered X-ray component S is expressed using the primary X-ray component P, a scattered-ray component can be estimated by solving Formula 1 based on P. Formula 2 is known as an approximation that expresses the scattered X-ray component S based on the primary X-ray component P.

S=−PlnP (Formula 2)

In step S305, the CPU 201 runs the scattered-ray-component reduction module 223, and the scattered-ray component estimated in step S304 is thereby reduced in the radiography image. At this time, the CPU 201 runs the radiography control module 211, and the degree of reduction of the scattered-ray component is thereby adjusted. For example, the degree is adjusted in accordance with the input manipulation by the operator. In another embodiment, the radiography settings for the input image are acquired from the RIS 110, retained in the RAM 202 or the SSD 206, and referred to, and the degree is thereby adjusted. At this time, information such as an X-ray tube voltage, X-ray tube current, an irradiation period of time, and the body mass index (BMI) of the object 104 is acquired. Specifically, the dosage of the X-rays entering the object 104 is acquired from the acquired information and utilized for the estimations using Formulae 1 and 2. In addition, the BMI is referred to, and if the input image is a radiography image of a big object, the degree of reduction of the estimated scattered-ray component is increased. If the input image is a radiography image of a small object, the degree of reduction of the estimated scattered-ray component is decreased. This enables the operator who observes the input image to perform appropriate image processing. This also enables appropriate image processing to be performed in consideration of an influence of the scattered-ray component on the input image.

In step S306, the CPU 201 runs the output module 214, and a corrected image is thereby output. An image having undergone not only processes in steps S303, S304, and S305 but also other image processing operations is output as the corrected image. For example, an image obtained by performing the gradation conversion processing on the image obtained in the processes described above based on the result of the analysis in step S301 is output as the corrected image. The analysis for the gradation process is performed before the captured radiography image is processed, and a process such as density conversion is performed on the image having undergone the image processing according to the first embodiment. This enables faster image processing. Specifically, if the gradation process is performed on an image not having undergone the image processing according to the embodiment of the invention, the gradation process needs likewise to be performed on, for example, the scattered-ray component estimated in the subsequent scattered-ray component estimation process, and thereafter the scattered-ray-component reduction process needs to be performed. This increases the calculation cost. In contrast, in step S306, the corrected image is stored in the PACS 112 and displayed on the monitor 107. The scattered X-ray component estimated in step S304 may be stored in the PACS 112 as image data different from the data regarding the corrected image or an image file.

The image processing device according to the first embodiment thereby enables appropriate image processing to be performed on a radiography image based on whether a grid is used for capturing the radiography image.

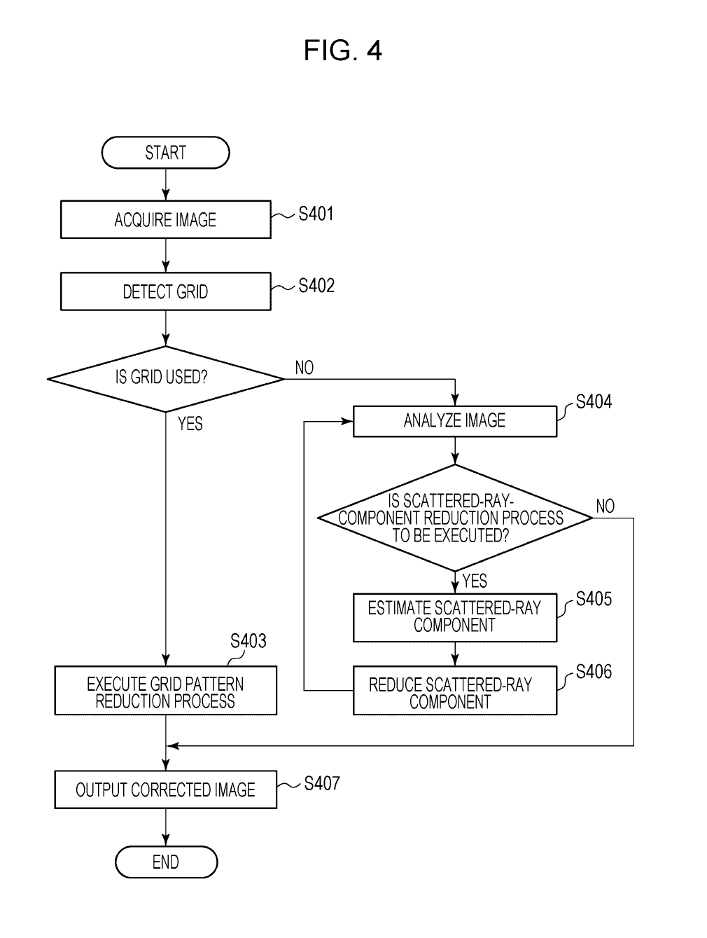

Subsequently, a process according to a second embodiment will be described based on FIG. 4. The process in the second embodiment has steps of analyzing the input image and determining whether to execute the scattered-ray-component reduction process. The process described below is executed by the CPU 201 or the GPU 208 of the controller 106 unless otherwise particularly noted. Since steps S401, S402, S403, S405, and S407 are the same as steps S301, S302, S303, S304, and S306 in FIG. 3, detailed description is omitted.

In step S402, the CPU 201 runs the detection module 221, and if the use of a grid is thereby detected, the process proceeds to step S403. If the non-use of a grid is detected, the process proceeds to step S404.

In step S404, the CPU 201 runs the radiography control module 211, and the input image is thereby analyzed. Based on the result of the analysis, it is determined whether to execute the scattered-ray-component reduction process.

For example, a histogram of the input image is acquired to acquire the contrast ratio. If the contrast ratio is sufficiently high, it is conceivable that the scattered X-rays have a very small influence on the input image. The scattered-ray-component reduction process is thus not performed, and the process proceeds to step S407. A threshold is set in advance, and if the contrast ratio has not reached the predetermined value yet (threshold), the scattered-ray-component reduction process is performed further, and the process proceeds to step S406. This enables the influence of the scattered-ray component on the input image to be considered based on the analysis of the image and thus enables appropriate image processing to be performed on the input image.

In addition, the radiography settings of the input image may be acquired from the RIS 110, retained in the RAM 202 or the SSD 206, and referred to. For example, if the radiographed part of the input image is a limb such as a hand, it is conceivable that the scattered rays has only a small influence on the radiography image. The scattered-ray-component reduction process is thus not performed, and the process proceeds to step S407. If the radiographed part of the input image is a thick part such as a chest, the scattered-ray-component reduction process is performed, and the process proceeds to step S406. To obtain information regarding the radiographed part, the input image may be analyzed by using a publicly known radiographed-part recognition algorithm. The fact that the scattered-ray component has various influences on the input image depending on the radiographed part is considered, and image processing appropriate for the input image can thereby be performed.

To determine whether to perform the scattered-ray-component reduction process, combination may be performed on the method in which the contrast ratio is acquired for the determination, the method in which the radiographed part is referred to for the determination, and any other publicly known method. The operator may select a method to be used for the determination.

In step S406, the CPU 201 runs the scattered-ray-component reduction module 223, and the scattered-ray component (estimated in step S405) is thereby reduced from the radiography image. At this time, the CPU 201 runs the radiography control module 211, and the degree of reduction is thereby adjusted. The degree of reduction is determined based on the contrast ratio analyzed in step S404. For example, it is conceivable that a lower contrast ratio leads to a larger influence of the scattered rays on the input image, and the degree of reduction of the scattered-ray component is thus increased. In another example, the degree of reduction is determined in accordance with the input manipulation by the operator.

The image processing device according to the second embodiment thereby enables control to be performed such that the scattered-ray-component reduction process is performed as necessary and thus enables appropriate image processing to be performed on the radiography image.

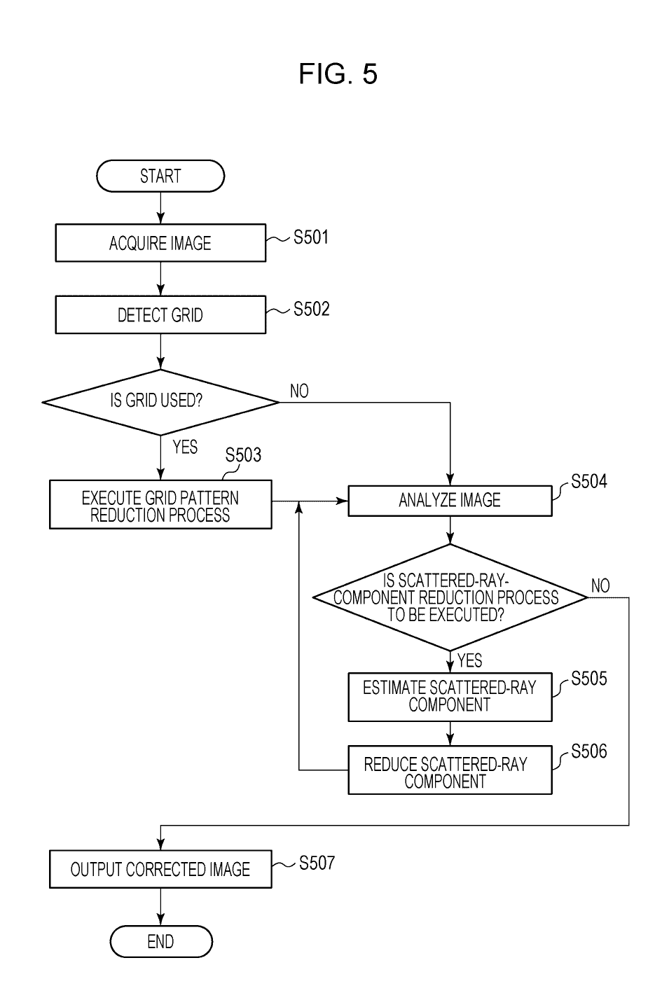

A process according to a third embodiment will be described based on FIG. 5. The process in the third embodiment has not only the steps of analyzing the input image and determining whether to execute the scattered-ray-component reduction process but also steps of analyzing an image having undergone the grid pattern reduction process or the scattered-ray-component reduction process and determining whether to further execute the scattered-ray-component reduction process. The process described below is executed by the CPU 201 or the GPU 208 of the controller 106 unless otherwise particularly noted. Since steps S501, S502, S503, and S507 are the same as steps S301, S302, S303, and S306 in FIG. 3, detailed description is omitted.

If the use of the grid is detected in step S502, the process proceeds to step S504. If the non-use of the grid is detected, the grid pattern reduction process is executed in step S503, and the process proceeds to step S504.

In step S504, the CPU 201 runs the radiography control module 211, and the input image or the image having undergone the grid pattern reduction process in step S503 is thereby analyzed. The analysis executed in the same manner as in step S404. If the scattered-ray-component reduction process is to be executed, the process proceeds to step S505. If the scattered-ray-component reduction process is not to be executed, the process proceeds to step S507.

In step S505, the CPU 201 runs the scattered-ray-component reduction module 223, and the scattered-ray component included in the radiography image is thereby estimated. In step S506, the scattered-ray component is reduced. If the non-use of the input image is detected in step S502, and if it is determined in step S504 that the scattered-ray-component reduction process is to be executed, the scattered-ray component is estimated in the same manner as in step S405, and the scattered-ray component is reduced in the same manner as in step S406. In step S506, the scattered-ray-component reduction process is executed, and the process proceeds to step S504 to analyze, in the same manner as in step S404, the image having undergone the scattered-ray-component reduction process. If it is determined that the scattered-ray-component reduction process is to be executed, steps S505 and S506 are performed, and the process then proceeds to step S504 to perform the image analysis further. The steps are repeated until it is determined that the scattered-ray-component reduction process is not to be executed anymore, and the process thus proceeds to step S507.

Steps S505 and S506 performed on the image having undergone the grid pattern reduction process in step S503 after the use of the grid for the input image is detected in step S502 will be described. Through the grid, the scattered rays and some of the primary radiation of the radiation transmitted through the object 104 are reduced. An input image M is expressed by using Formula 3 where P denotes primary radiation without the grid, S denotes a scattered ray, L denotes a grid pattern, α denotes the grid transmittance of the primary radiation, and β denotes the grid transmittance of the scattered ray.

M=αP+βS+L (Formula 3)

Based on the characteristics of the grid, α and β are determined. The grid pattern is superposed on the input image M, and the grid pattern reduction process is performed in step S503. An image having undergone the grid pattern reduction process is denoted by M′, and M′ is expressed by using Formula 4.

M′=αP+βS (Formula 4)

In step S505, α and β are obtained based on the grid used for capturing the input image M, and the scattered ray S is estimated in the same manner as in step S405. In step S506, the grid transmittance of the scattered ray is set to a value β′ that is smaller than β, and the scattered-ray component can thereby be reduced.

In step S506, the scattered-ray-component reduction process is executed. The process proceeds to step S504 again, and the image having undergone the scattered-ray-component reduction process is analyzed in the same manner as in step S404. If it is determined that the scattered-ray-component reduction process is to be executed, steps S505 and S506 are performed. The process proceeds to step S504 to analyze the image. The steps are repeated until it is determined that the scattered-ray-component reduction process is not to be executed and the process thus proceeds to step S507.

The image processing device according to the third embodiment enables image processing appropriate for the radiography image to be performed based on whether the grid is used for capturing the radiography image and whether the influence of the scattered-ray component on the radiography image is sufficiently reduced.

A process according to a fourth embodiment will be described based on FIG. 6. FIG. 6 is a diagram illustrating display output on a monitor by an image processing device according to the fourth embodiment of the invention. A region 601 is used to display an input image or a corrected image.

A region 602 is used to display icons for selecting a process to be executed on an input image or a corrected image. For example, an icon 602a is used for selecting a process for displaying information such as radiography settings. Icons 602b to 602j are used for selecting image processing to be performed on the input image or the corrected image. An icon 602k is used for selecting a process for performing radiography again. An icon 602l is used for selecting a process for preventing a radiography image inappropriate for a diagnosis, a so-called failure image from being used when the operator determines that the radiography image is a failure image. When the operator performs input for selecting the icon 602l, the CPU 201 runs the display control module 215 to display a screen for entering a reason for the determination of the failure image.

A region 603 is used to display whether the FPD 102 is ready for radiography. The radiography control module 211 controls the display control module 215 based on a result of receiving a signal indicating the state of the FPD 102. When the FPD 102 is ready for radiography, “READY” is displayed. When the FPD 102 is in a state inappropriate for the radiography, “NOT READY” is displayed.

A region 604 is used to display information regarding a patient such as the name, the ID, and the age of the patient.

A region 605 is used to display information regarding radiography settings for capturing a radiography image of the patient to be displayed in the region 601. At this time, a region 606 may be used to display information regarding radiography settings for capturing a different radiography image of the patient.

A region 610 is used to display information related to the grid pattern reduction process. A region 620 is used to display information related to the scattered-ray-component reduction process. Checking a checkbox 611 by the operator with the operation unit 108 leads to a setting in which the controller 106 is allowed to execute the grid pattern reduction process. Likewise, checking a checkbox 621 by the operator leads to a setting in which the controller 106 is allowed to execute the scattered-ray-component reduction process. In the display of regions at this time, a region related to the set function is desirably enabled, and a region related to a function not set is desirably disabled except the checkbox for the function. The enabled region and the disabled region may be distinguishably displayed such as by changing the colors. The region related to the set function may not be displayed or may be controlled in such a manner that the region is enabled but the function is not implemented despite the input manipulation.

Hereinafter, the process according to the fourth embodiment will be described based on FIG. 5. In the case of a setting allowing the grid pattern reduction process, the CPU 201 runs the radiography control module 211, and the process thereby proceeds to step S503. At this time, the radiography control module 211 may simultaneously perform the grid detection in step S502. If the non-use of the grid is detected in step S502 despite the setting allowing the grid pattern reduction process, the radiography control module 211 may control the display control module 215 to display a screen through which the operator is notified that the grid is not being used. This enables reduction of the possibility that a component related to the object structure is reduced due to execution of the grid pattern reduction process despite the non-use of the grid for the radiography. A region 612 is used for inputting the type of grid used. Step S503 may be performed in accordance with the content of input in the region 612 performed by the operator. A plurality of selectable grids input in advance may be displayed in the region 612. The radiography control module 211 may refer to the radiography settings to control manipulation of the checkboxes 611 and 621. For example, in a case where the radiographed part is a part such as a limb for which the grid is not generally used, and when manipulation for a setting for the grid pattern reduction process is performed, the display control module 215 may be started and display a screen for notifying the operator that the image of the radiographed part has been captured without using the grid. In addition, control may be performed to disable a region 611.

Likewise, in the case of a setting allowing the scattered-ray-component reduction process, the CPU 201 runs the radiography control module 211, and the process thereby proceeds to step S504. At this time, the radiography control module 211 may simultaneously perform the grid detection in step S502. This enables reduction of the likelihood of the accuracy of estimating the scattered-ray component deteriorating due to estimation of the scattered-ray component despite the use of the grid for radiography. A region 622 may be used for the operator to input the degree of reduction of the scattered-ray component. The degree of reduction is expressed in a frame “Effect” by using, for example, ten steps expressed by values. The operator may directly input a value. An icon allowing a value to be incremented or decremented by one step may be displayed and used for operator manipulation. The degree of reduction may be expressed by using a number line, and an icon indicating the effect on the number line may be displayed and used for operator manipulation. The radiography control module 211 adjusts the degree of reduction in step S506 in accordance with the input in the region 622 performed by the operator. If the contrast ratio has not reached the predetermined value as a result of reduction performed in accordance with the input manipulation, the radiography control module 211 may control the display control module 215 in step S504 to display a screen for prompting the operator to increase the degree of reduction. This enables appropriate image processing and an enhanced image quality of the radiography image. The operator may set in advance the upper limit of the aforementioned contrast ratio, and the scattered-ray-component reduction process may not be performed if the contrast ratio exceeds the predetermined upper limit. This enables image processing to be selected to provide an observer of a radiography image with an easy-to-observe image.

An icon 631 is used for selecting a process for holding a processing in progress. An icon 632 is used for selecting a process for outputting, to the PACS 112 or other components, the radiography image displayed in the region 601 or an image having undergone the image processing. The process and the input manipulation of the icon 632 may be executed before the test is completed. An icon 633 is used for selecting a process for completing the test. With reference to the flowchart in FIG. 3, step S306 is performed in accordance with the input manipulation of the icon 633.

Although the image processing device in each embodiment described above is a single device, the embodiment of the invention includes a configuration in which the processes described above are executed in an image processing system in which a plurality of devices including an information processing device are communicably combined with each other. Alternatively, the processes described above may be executed by a server device or a server group shared by a plurality of modalities. It is only required that a plurality of devices included in an information system or the image processing system are communicable at a predetermined communication rate and do not have to exist in the same facility or same country.

The embodiments of the invention also include a configuration in which software programs that implement the functions in the embodiment described above are supplied to a system or an apparatus and in which the computer of the system or the apparatus reads out and executes the code of one of the supplied programs.

Accordingly, the embodiments of the invention also include the program code itself to be installed on the computer to implement the processes according to the embodiments on the computer. An operating system or the like running on the computer may perform some or all of the actual processes based on instructions included in the program read out by the computer, and the processes may also implement the functions of the embodiments described above.

The embodiments of the invention include a configuration in which the embodiments described above are appropriately combined.

The embodiments described above enable the image quality of the radiography image to be enhanced by changing the image processing operations based on the use or non-use of the grid or the type of grid, the image processing operations being provided for reducing the influence of the scattered rays for the captured radiography image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-110213, filed May 29, 2015, which is hereby incorporated by reference herein in its entirety.

What is claimed is:

1. An image processing device comprising:
an acquisition unit that acquires a radiography image;
a detector that detects use or non-use of a grid for capturing the radiography image;
a grid pattern reduction unit that reduces a grid pattern included in the radiography image;
a scattered-ray-component reduction unit that estimates a scattered-ray component included in the radiography image and performs reduction of the scattered-ray component; and
a controller that performs control to cause the grid pattern reduction unit to perform processing if the detector detects the use of the grid and to cause the scattered-ray-component reduction unit to perform processing if the detector detects the non-use of the grid.

2. The image processing device according to claim 1,
wherein, if a contrast ratio of an image having undergone the processing performed by the grid pattern reduction unit or the processing performed by the scattered-ray-component reduction unit has not reached a predetermined value yet, the controller performs control to cause the scattered-ray-component reduction unit to perform the processing further.

3. The image processing device according to claim 1,
wherein, if a part of the radiography image is a limb, the controller performs control to cause the scattered-ray-component reduction unit not to perform the processing.

4. The image processing device according to claim 1, further comprising:
an adjuster that adjusts a degree of the reduction.

5. The image processing device according to claim 4,
wherein the adjuster adjusts the degree of the reduction by causing the scattered-ray-component reduction unit to perform the processing if a contrast ratio of an image has not reached a predetermined contrast ratio yet and by causing the scattered-ray-component reduction unit not to perform the processing if the contrast ratio has reached the predetermined contrast ratio.

6. The image processing device according to claim 4,
wherein, if a contrast ratio of an image has reached a predetermined contrast ratio, the adjuster adjusts the degree of the reduction based on the contrast ratio.

7. The image processing device according to claim 4,
wherein the adjuster adjusts the degree of the reduction based on at least one radiography setting for an X-ray tube voltage, X-ray tube current, an irradiation period of time, or a radiographed part.

8. The image processing device according to claim 7,
wherein, if the radiographed part is a limb, the adjuster adjusts the degree of the reduction by causing the scattered-ray-component reduction unit not to perform the processing.

9. The image processing device according to claim 1,
wherein, if the detector detects the use of the grid, the controller causes the grid pattern reduction unit to perform the processing and the scattered-ray-component reduction unit to perform the processing.

10. The image processing device according to claim 1,
wherein, when the radiography image includes a specific spatial frequency component, the detector detects the use of the grid.

11. The image processing device according to claim 1, further comprising:
a determination unit that determines, in accordance with input manipulation, whether the scattered-ray-component reduction unit performs the processing.

12. The image processing device according to claim 11, further comprising:
a notification unit that makes notification of the non-use of the grid in a case where the grid pattern reduction unit performs the processing but where the detector does not detect the grid.

13. The image processing device according to claim 1, further comprising:
a gradation converter that makes an analysis for performing gradation conversion on an image and performs the gradation conversion,
wherein, if the detector detects the non-use of the grid, the gradation converter performs the gradation conversion on an image that has undergone the processing performed by the scattered-ray-component reduction unit after the analysis of the radiography image acquired by the acquisition unit, and if the detector detects the use of the grid, the gradation converter performs the gradation conversion on an image having undergone the analysis and the processing performed by the grid pattern reduction unit.

14. An image processing method comprising the steps of:
acquiring a radiography image;
detecting use or non-use of a grid for acquiring the radiography image;
reducing a grid pattern included in the radiography image;
estimating and reducing a scattered-ray component included in an image acquired by performing the reducing of the grid pattern on the radiography image; and
determining, in accordance with input manipulation, whether to proceed to the reducing of the scattered-ray component.

15. An image processing device including
a processor and
a memory that stores a program including instructions for causing the processor to execute a process comprising:
acquiring a radiography image;
detecting use or non-use of a grid for the radiography image;
reducing a grid pattern included in the radiography image;
estimating and reducing a scattered-ray component included in an image acquired by performing the reducing of the grid pattern on the radiography image; and
determining, in accordance with input manipulation, whether to proceed to the reducing of the scattered-ray component.

16. A non-transitory recording medium for causing a computer to execute a process comprising:
acquiring a radiography image;
detecting use or non-use of a grid for the radiography image;
reducing a grid pattern included in the radiography image;
estimating and reducing a scattered-ray component included in an image acquired by performing the reducing of the grid pattern on the radiography image; and
determining, in accordance with input manipulation, whether to proceed to the reducing of the scattered-ray component.
